(19) United States
(12) Patent Application Publication
(10) Pub. No.: US 2003/0194041 A1
(43) Pub. Date: Oct. 16, 2003

(54) TEST SAMPLE REMOVAL APPARATUS AND METHOD

(76) Inventor: Grant Clark Jensen, Morgan Hill, CA (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/063,320

(22) Filed: Apr. 10, 2002

(51) Int. Cl. G21C 19/00

(52) U.S. Cl. 376/260

(57) ABSTRACT

In an exemplary embodiment, an electric discharge machining sample removal apparatus for removing a material sample from a structural component in a boiling water nuclear reactor includes a base plate, a motor mounted on the base plate, and an electrode assembly rotatably coupled to the base plate and operatively coupled to the motor. The electrode assembly includes an outer wall defining a substantially semi-cylindrical hollow cavity. The outer wall includes a conductive first arcuate portion a conductive second arcuate portion and a non-conductive third arcuate portion positioned between and coupled to the first and second arcuate portions.

### BACKGROUND OF INVENTION

This invention relates generally to inspection of nuclear reactors, and more particularly to an electric discharge machining (EDM) apparatus for obtaining a material sample within a nuclear reactor pressure vessel.

A reactor pressure vessel (RPV) of a boiling water reactor (BWR) typically has a generally cylindrical shape and is closed at both ends, e.g., by a bottom head and a removable top head. A top guide typically is spaced above a core plate within the RPV.

A core shroud, or shroud, typically surrounds the core and is supported by a shroud support structure. Particularly, the shroud has a generally cylindrical shape and surrounds both the core plate and the top guide. There is a space or annulus located between the cylindrical reactor pressure vessel and the cylindrically shaped shroud.

Internal structures of operating BWRs are susceptible to various corrosive and cracking processes. Stress corrosion cracking (SCC) is one known phenomenon occurring in reactor components, such as structural members, piping, fasteners, and welds, exposed to high temperature water. The reactor components are subject to a variety of stresses associated with, for example, differences in thermal expansion, the operating pressure needed for the containment of the reactor cooling water, and other sources such as residual stresses from welding, cold working and other inhomogeneous metal treatments. In addition, water chemistry, welding, heat treatment and radiation can increase the susceptibility of metal in a component to Scc.

When cracking does occur in these internal structures, it is desirable to characterize the cracking mechanism by obtaining a small sample of the subject material to perform metallurgical evaluations. A metallurgical evaluation assists in understanding the cause of the corrosion and cracking and thus assists in identifying ways of mitigating further degradation of reactor internals.

### SUMMARY OF INVENTION

In one aspect, an electric discharge machining sample removal apparatus for removing a material sample from a structural component in a boiling water nuclear reactor is provided. The reactor includes a reactor pressure vessel and a shroud. The apparatus includes a base plate, a motor mounted on the base plate, and an electrode assembly rotatably coupled to the base plate and operatively coupled to the motor. The electrode assembly includes an outer wall defining a substantially semi-cylindrical hollow cavity. The outer wall includes a conductive first arcuate portion, a conductive second arcuate portion and a non-conductive third arcuate portion positioned between and coupled to the first and second arcuate portions. In another aspect, an electric discharge machining electrode assembly for a sample removal apparatus is provided. The electrode assembly includes an outer wall defining a substantially semi-cylindrical hollow cavity. The outer wall includes a conductive first arcuate portion a conductive second arcuate portion and a non-conductive third arcuate portion positioned between and coupled to the first and second arcuate portions.

In another aspect, an electric discharge machining sample removal apparatus for removing a material sample from a structural component in a boiling water nuclear reactor is provided. The reactor includes a reactor pressure vessel and a shroud. The apparatus includes a base plate, a motor mounted on the base plate, and an electrode assembly rotatably coupled to the base plate and operatively coupled to the motor. The electrode assembly has a first end and a second end, and includes a first electrode hub located at the first end, a second electrode hub located at the second end, a conductive first electrode wing portion extending from the first and second electrode hubs, a conductive second electrode wing portion extending from the first and second electrode hubs, and an electrode insulator extending between the first and second electrode wing portions and coupled to the first and second electrode hubs. The first and second electrode wing portions and the electrode insulator forming a substantially semi-cylindrical hollow cavity having an outer wall.

In another aspect, a method of excavating a material sample from a structural component in a nuclear reactor is provided. The reactor includes a reactor pressure vessel and a shroud with an annulus space between the pressure vessel and the shroud. The method includes positioning an electric discharge machining sample removal apparatus in the annulus and adjacent the shroud, and activating the sample removal apparatus to machine a material sample from the shroud. The sample removal apparatus includes a base plate, a motor mounted on the base plate, and an electrode assembly rotatably coupled to the base plate and operatively coupled to the motor. The electrode assembly has a first end and a second end, and includes a first electrode hub located at the first end, a second electrode hub located at the second end, a conductive first electrode wing portion extending from the first and second electrode hubs, a conductive second electrode wing portion extending from the first and second electrode hubs, and an electrode insulator extending between the first and second electrode wing portions and coupled to the first and second electrode hubs. The first and second electrode wing portions and the electrode insulator forming a substantially semi-cylindrical hollow cavity having an outer wall.

### BRIEF DESCRIPTION OF DRAWINGS

FIG. 1 is a sectional view, with parts cut away, of a boiling water nuclear reactor pressure vessel.

FIG. 2 is a left front perspective view of a sample removal apparatus in accordance with an embodiment of the present invention.

FIG. 3 is a right front perspective view of the apparatus shown in FIG. 2.

FIG. 4 is a left rear perspective view of the apparatus shown in FIG. 2.

FIG. 5 is a right rear perspective view of the apparatus shown in FIG. 2.

FIG. 6 is a bottom perspective view of the apparatus shown in FIG. 2.

FIG. 7 is a perspective view of an electrode shown in the apparatus shown in FIG. 2.

FIG. 8 is a sectional view of an electrode mount shown in the apparatus shown in FIG. 2.

FIG. 9 is a sectional view of a spindle shaft shown in the apparatus shown in FIG. 2.

FIG. 10 is a left front perspective view of the apparatus shown in FIG. 2 with the clamping assembly in the stored position.

FIG. 11 is a perspective view of a sample removed from the shroud shown in FIG. 1 by the apparatus shown in FIG. 2.

### DETAILED DESCRIPTION

An electric discharge machining (EDM) sample removal apparatus that is capable of obtaining material samples from a boiling water nuclear reactor shroud structure is described below in more detail. The EDM sample removal apparatus is easily positioned in the reactor between the shroud and the reactor pressure vessel and is capable of maintaining position in the reactor to complete the process of material extraction from the shroud structure.

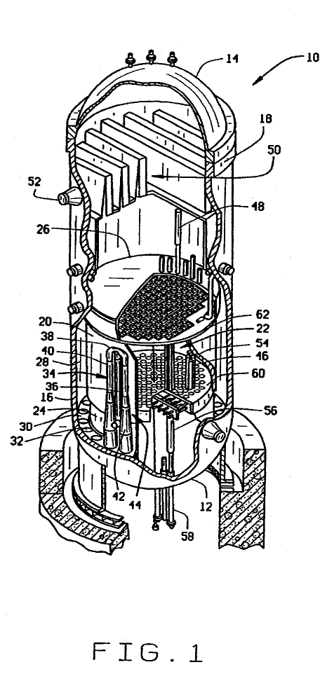

Referring now to the figures, FIG. 1 is a sectional view, with parts cut away, of a boiling water nuclear reactor pressure vessel (RPV) 10. RPV 10 has a generally cylindrical shape and is closed at one end by a bottom head 12 and at its other end by a removable top head 14. A side wall 16 extends from bottom head 12 to top head 14. Side wall 16 includes a top flange 18. Top head 14 is attached to top flange 18. A cylindrically shaped core shroud 20 surrounds a reactor core 22. Shroud 20 is supported at one end by a shroud support 24 and includes a removable shroud head 26 at the other end. An annulus 28 is formed between shroud 20 and side wall 16. A pump deck 30, which has a ring shape, extends between shroud support 24 and RPV side wall 16. Pump deck 30 includes a plurality of circular openings 32, with each opening housing a jet pump 34. Jet pumps 34 are circumferentially distributed around core shroud 20. An inlet riser pipe 36 is coupled to two jet pumps 34 by a transition assembly 38. Each jet pump 34 includes an inlet mixer 40, and a diffuser 42. Inlet riser 36 and two connected jet pumps 34 form a jet pump assembly 44.

Heat is generated within core 22, which includes fuel bundles 46 of fissionable material. Water circulated up through core 22 is at least partially converted to steam. Steam separators 48 separates steam from water, which is recirculated. Residual water is removed from the steam by steam dryers 50. The steam exits RPV 10 through a steam outlet 52 near vessel top head 14.

The amount of heat generated in core 22 is regulated by inserting and withdrawing control rods 54 of neutron absorbing material, such as for example, boron carbide. To the extent that control rod 54 is inserted into fuel bundle 46, it absorbs neutrons that would otherwise be available to promote the chain reaction which generates heat in core 22. Control rod guide tubes 56 maintain the vertical motion of control rods 54 during insertion and withdrawal. Control rod drives 58 effect the insertion and withdrawal of control rods 54. Control rod drives 58 extend through bottom head 12.

Fuel bundles 46 are aligned by a core plate 60 located at the base of core 22. A top guide 62 aligns fuel bundles 46 as they are lowered into core 22. Core plate 60 and top guide 62 are supported by core shroud 20.

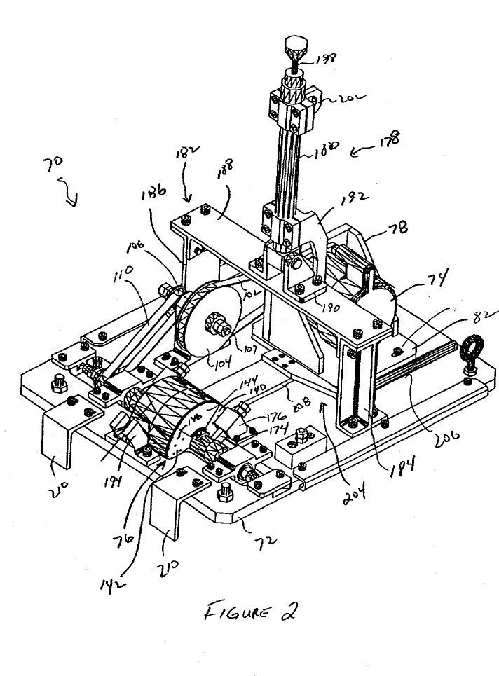

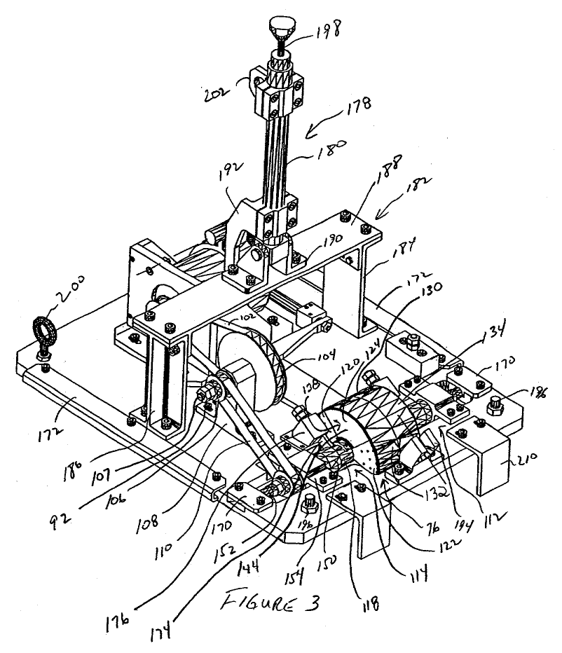

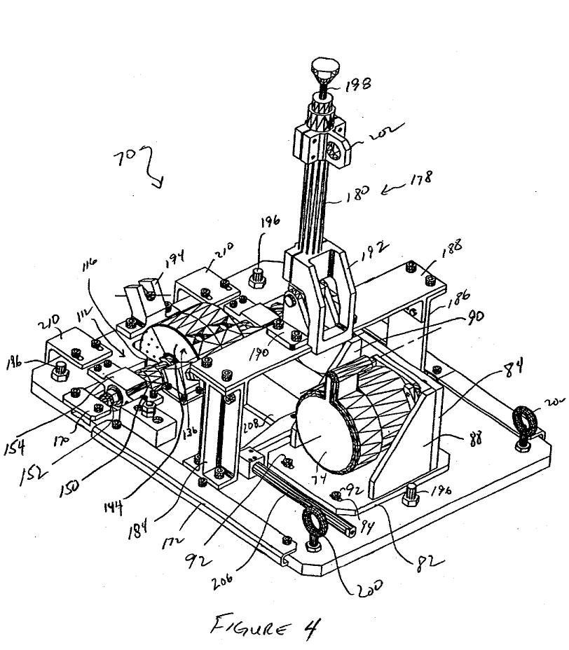

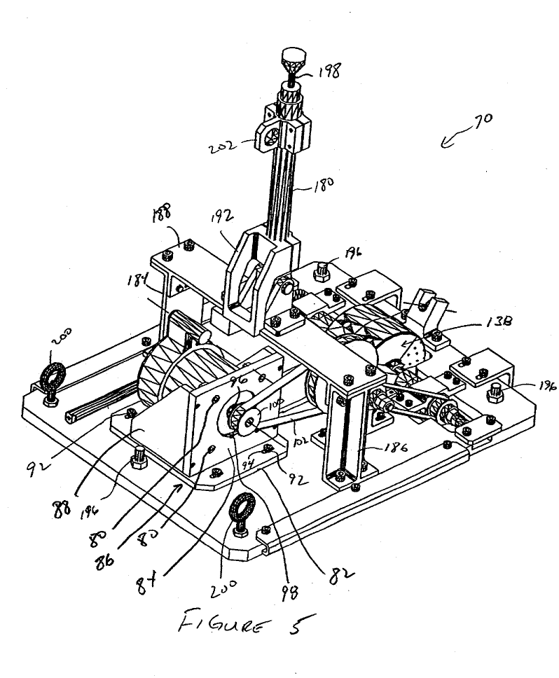

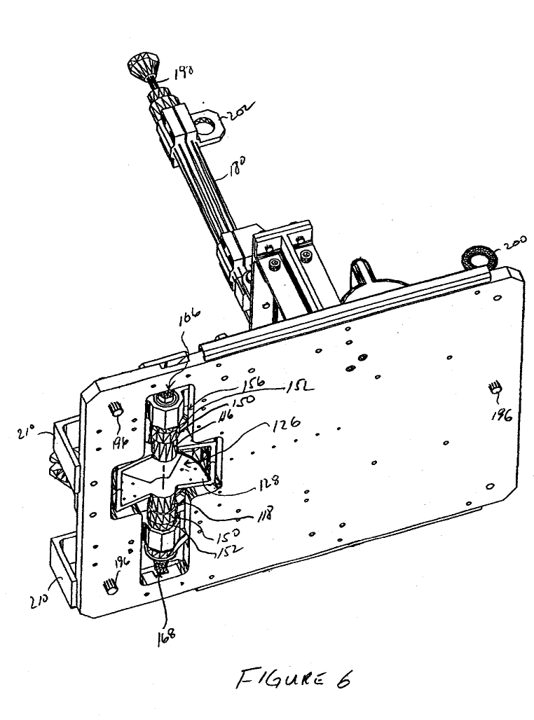

FIG. 2 is a left front perspective view of an EDM sample removal apparatus 70 in accordance with an embodiment of the present invention. FIG. 3 is a right front perspective view of apparatus 70, FIG. 4 is a left rear perspective view of apparatus 70, FIG. 5 is a right rear perspective view of apparatus 70, and FIG. 6 is a bottom perspective view of apparatus 70. Referring to FIGS. 2-6, in an exemplary embodiment, apparatus 70 includes a base plate 72, a motor 74 mounted on base plate 72, and an electrode assembly 76 rotatably coupled to base plate 72 and operatively coupled to motor 74.

Specifically, reversible stepper motor 74 is attached to a motor mounting bracket 78 with fasteners 80. Motor mounting bracket 78 includes a bracket base 82 with a bracket support plate 84 attached to bracket base 82. Bracket support plate 84 extends at substantially 90 degrees from an end portion 86 of bracket base 82. Gusset plates extend between support plate 84 and bracket base 82 and are attached to bracket base 82 and opposing ends of support plate 84. Bracket base 82 is attached to base plate 72 by fasteners 92 extending through base plate 72 and oblong fastener openings 94 in bracket base 82. Oblong openings 94 permit adjustment of the position of motor 74. A drive shaft 96 extends from motor 74 through an opening 98 extending through bracket support plate 84. A motor pulley 100 is attached to motor drive shaft 96.

A motor output belt 102 extends between and operatively couples motor pulley 100 and a first speed reduction pulley 104. A second speed reduction pulley 106 and first speed reduction pulley 104 are coupled to opposing end portions of a shaft 107 that is rotatably mounted in a speed reduction bearing block 108 which is attached to base plate 72 by fasteners 92. In alternate embodiments, bearing block 108 is attached to base plate by any suitable method, for example by welding. A drive belt 110 extends between and operatively couples second speed reduction pulley 106 and electrode assembly 76.

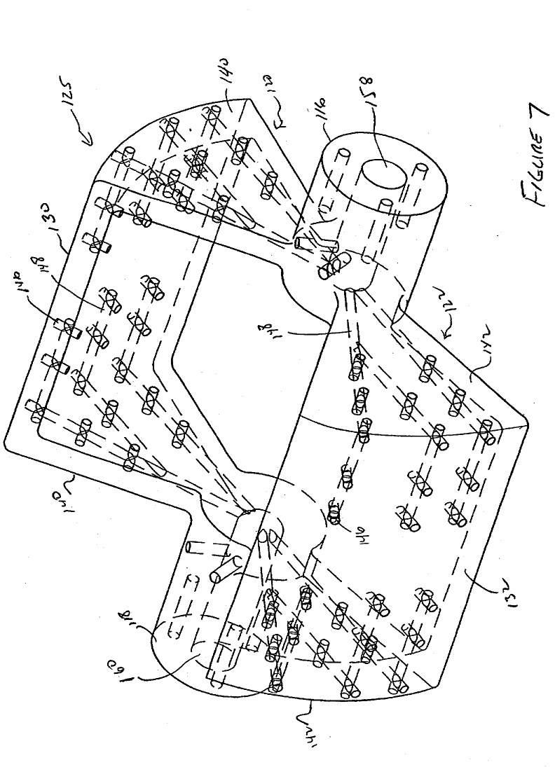

Referring also to FIG. 7, electrode assembly 76 has a first end 112 and a second end 114, and includes a first electrode hub 116 located at first end 112, a second electrode hub 118 located at second end 114, a conductive first electrode wing portion 120 extending from first and second electrode hubs 116 and 118, a conductive second electrode wing portion 122 extending from first and second electrode hubs 116 and 118, and an electrode insulator 124 extending between first and second electrode wing portions 120 and 122 and coupled to first and second electrode hubs 116 and 118. First and second electrode wing portions 120 and 122 and first and second electrode hubs 116 and 118 form EDM electrode 125. Electrode wing portions 120 and 122 and electrode insulator 124 form a substantially semi-cylindrical hollow cavity 126 having an outer wall 128. In one embodiment, EDM electrode 125 is formed as a single piece, and in alternate embodiments, EDM electrode 125 is formed from a plurality of pieces bonded together.

Outer wall 128 includes a conductive first arcuate portion 130, a conductive second arcuate portion 132 and a non-conductive third arcuate portion 134 positioned between first and second arcuate portions 130 and 132. Outer wall 128 further includes a first end portion 136 and a second end portion 138, with end portions 136 and 138 each including a conductive first end section 140 extending from first arcuate portion 130, a conductive second end section 142 extending from second arcuate portion 132, and a non-conductive third end section 144 extending from third arcuate portion 134. First and second end sections 140 and 142 of first end portion 136 extend from first electrode hub 116, and first and second end sections 140 and 142 of second end portion 138 extend from second electrode hub 118. Third end section 144 of first end portion 136 is coupled to first electrode hub 116, and third end section 144 of second end portion 138 is coupled to second electrode hub 118.

First and second electrode wing portions 120 and 122 each include a plurality of flushing bores 146 extending through outer wall 128 and a plurality of interconnecting bores 148. Each interconnecting bore 148 extends between and interconnects at least two flushing bores 146.

Each electrode hub 116 and 118 is coupled to an electrode mount 150, and each electrode mount 150 is coupled to a spindle shaft 152. Each spindle shaft 152 is received in a bearing block 154 which is attached to base plate 72 thereby rotatably coupling electrode assembly 76 to base plate 72. An opening 156 in base plate 72 is sized and shaped to receive electrode assembly 76, and bearing blocks 154 are sized to span opening 156 to position electrode assembly 76 within opening 156.

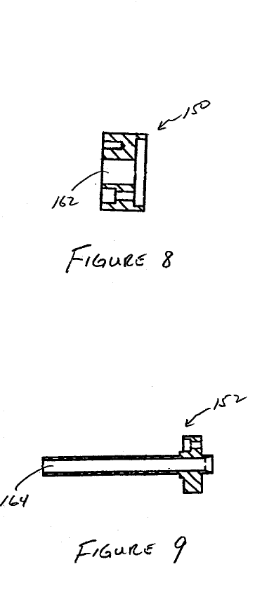

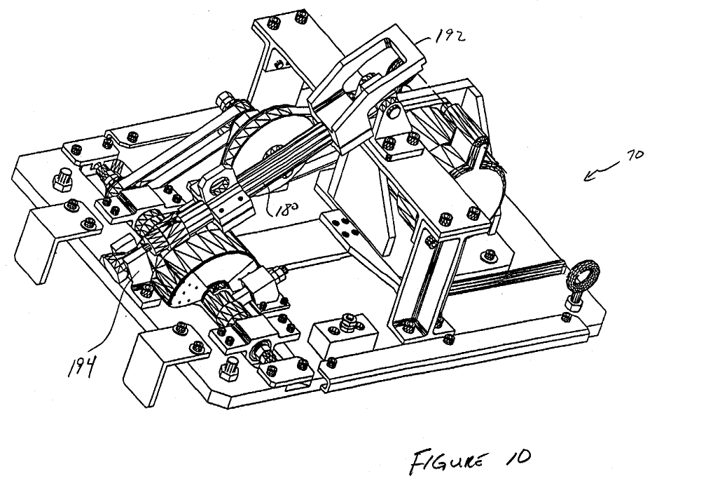

Axial bores 158 and 160 extend through electrode hubs 116 and 118 respectively. Referring also to FIGS. 8 and 9, an axial bore 162 extends through each electrode mount 150, and an axial bore 164 extends through each spindle shaft 152. Axial bores 164, 162, and 158 of spindle shaft 152 coupled to electrode mount 150 coupled to first electrode hub 116 align to form a first passageway 166 extending from inside electrode assembly cavity 126 to outside said cavity 126. Axial bores 164, 162, and 160 of spindle shaft 152 coupled to electrode mount 150 coupled to second electrode hub 118 align to form a second passageway 168 extending from inside electrode assembly cavity 126 to outside cavity 126.

The debris formed during the EDM process is referred to as swarf. The swarf and dissociated hydrogen and oxygen produced during the EDM cutting process are removed by either flushing water or providing suction through flushing bores 146 and interconnecting bores 148. This network of flushing bores 146 and interconnecting bores 148 communicate with electrode assembly cavity 126 and first and second passageways 166 and 168 to remove the swarf from the cutting area. Also, because flushing bores 146 extend through outer wall 128, the swarf is also removed from areas outside cavity 126 and adjacent electrode 125. Tubing (not shown) from a swarf collection system (not shown) attaches to the distal end of each spindle shaft 152 to communicate with passageways 166 and 168 for removal of the swarf and the dissociated hydrogen and oxygen produced during the EDM cutting operation. Tube restraints 170 and tube covers 172 are attached to base plate 72 to protect the swarf collection tubing (not shown).

Brushes 174 are mounted in brush holders 176 which are coupled to base plate 72 adjacent electrode assembly 76. Brushes 174 are coupled to an electrical line (not shown) and engage electrode hubs 116 and 118 to supply electrical voltage to electrode wing portions 120 and 122. Electrode mounts 150 are fabricated from a non-conductive material to electrically insulate EDM electrode 125.

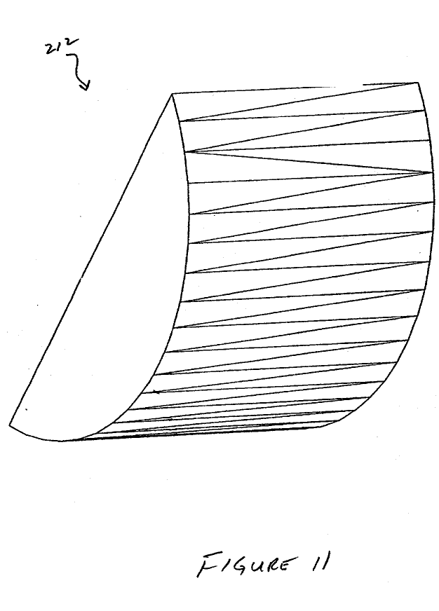

Apparatus 70 also includes a clamping assembly 178 coupled to base plate 72. Clamping assembly 178 includes an extendable clamping cylinder 180 sized and configured to engage reactor pressure vessel 10 to clamp apparatus 70 in place between reactor pressure vessel side wall 16 and shroud 20. A cylinder mount assembly 182 is coupled to base plate 72. Cylinder mount assembly includes frame members 184 and 186 coupled to and extending substantially perpendicular to base plate 72. A beam 188 extends between and is coupled to frame members 184 and 186. A cylinder mounting bracket 190 is coupled to beam 188, and clamping cylinder 180 is pivotally coupled to mounting bracket 190. A stop bracket 192 is coupled to clamping cylinder 180. Stop bracket 192 engages beam 188 to limit pivoting motion of clamping cylinder 180. A cylinder rest bracket 194 is attached to base plate 72 receives clamping cylinders 180 when clamping cylinder 180 is pivoted to a stored position (see FIG. 10). Adjustable leveling studs 196 extend from a bottom surface of base plate 72. When clamping cylinder 180 is activated extending plunger 198 into contact with RPV side wall 16 the force developed is transmitted to leveling studs 196 which bear on the curved surface of shroud 20. Leveling studs 196 are adjusted prior to installation of apparatus 70 to accommodate for the curvature of shroud 20. Also the adjustment of leveling studs 196 permit minor adjustment to the depth of cut that EDM electrode 125 makes in shroud 20. Eyebolts 200 are attached to base plate 72 and a tether assembly 202 is coupled to clamping cylinder 180. Eyebolts 200 and tether assembly 202 are sized to permit the attachment of ropes which are used to lower and suspend apparatus 70 in reactor annulus 28.

Apparatus 70 also includes a trap door assembly 204 movably coupled to base plate 72. Trap door assembly 204 includes a door actuating cylinder 206 coupled to base plate 72 and a trap door 208 coupled to door actuating cylinder 206. Door 208 is movable from an open position to a closed position to capture a sample machined from shroud 20.

Apparatus 70 is used to extract a material sample from shroud 20. Clamping cylinder 180 is released from cylinder rest bracket 194 and is pivoted to an operating position with stop bracket 192 engaging mounting assembly beam 188. Ropes are attached to eye bolts 200 and tether assembly 202 and apparatus 70 is lowered into reactor annulus 28 and into position adjacent shroud 20 with positioning brackets 210 engaging shroud 20. In one embodiment, positioning brackets 210 engage one of the shroud flanges (not shown) that extend into annulus 28. In alternate embodiments, positioning brackets engage other features of shroud 20. Clamping cylinder 180 is activated which extends plunger 198 into contact with RPV side wall 16. The force developed by clamping cylinder is transmitted to leveling studs 196 which bear on the curved surface of shroud 20 and clamp apparatus into place with electrode assembly 76 adjacent shroud 20.

Electric current is supplied to EDM electrode 125 and motor 74 is activated rotating electrode 125 into position to machine into shroud 20. Electrode 125 is first rotated so that first electrode wing portion 120 machines into shroud 20. When approximately half of the machining is complete, motor 74 is reversed and electrode 125 is rotated so that second electrode wing portion 122 machines into shroud 20. Just as the machining path of second wing portion 122 meets the machining path that was performed by first wing portion door actuating cylinder 206 is activated moving trap door 208 into a closed position trapping a sample 212 (see FIG. 11) machined from shroud 20 between trap door 208 and electrode insulator 124.

Clamping cylinder 180 is deactivated which retracts plunger 198 and releases apparatus 70 from engagement with shroud 20. Apparatus 70 is then lifted from annulus 28 which also removes sample 212 trapped between trap door and electrode insulator 124 from annulus 28.

While the invention has been described in terms of various specific embodiments, those skilled in the art will recognize that the invention can be practiced with modification within the spirit and scope of the claims.

1. An electric discharge machining sample removal apparatus for removing a material sample from a structural component in a boiling water nuclear reactor, the reactor comprising a reactor pressure vessel and a shroud, said apparatus comprising:
a base plate;
a motor mounted on said base plate; and
an electrode assembly rotatably coupled to said base plate and operatively coupled to said motor, said electrode assembly comprising an outer wall defining a substantially semi-cylindrical hollow cavity, said outer wall comprising:
a conductive first arcuate portion;
a conductive second arcuate portion; and
a non-conductive third arcuate portion positioned between and coupled to said first and second arcuate portions.

2. An apparatus in accordance with claim 1 further comprising a clamping assembly coupled to said base plate, said clamping assembly comprising an extendable clamping cylinder sized and configured to engage the reactor pressure vessel to clamp said apparatus in place between the reactor pressure vessel and the shroud.

3. An apparatus in accordance with claim 1 further comprising a trap door assembly movably coupled to said base plate.

4. An apparatus in accordance with claim 3 wherein said trap door assembly comprises a door actuating cylinder coupled to said base plate and a trap door coupled to said door actuating cylinder, said door movable from an open position to a closed position to capture a sample.

5. An apparatus in accordance with claim 1 further comprising at least one drive belt operatively coupling said motor to said electrode assembly.

6. An apparatus in accordance with claim 1 wherein said outer wall further comprises a first end portion and a second end portion, each said first and said second end portion comprise:
a conductive first end section extending from said first arcuate portion;
a conductive second end section extending from said second arcuate portion;
a non-conductive third end section extending from said third arcuate portion; and
a conductive electrode hub, said first and second end sections extending from said electrode hub and said third end section coupled to said electrode hub.

7. An apparatus in accordance with claim 6 wherein said first end sections of said first and second end portions and said first arcuate portion defines a first electrode wing, said second end sections of said first and second end portions and said second arcuate portion defines a second electrode wing, and said third end sections of said first and second end portions and said third arcuate portion defines an electrode insulator, said first and second electrode wings each comprising a plurality of flushing bores extending through said outer wall and a plurality of interconnecting bores, each said interconnecting bore interconnecting at least two of said flushing bores.

8. An apparatus in accordance with claim 6 wherein each electrode hub is coupled to an electrode mount, and each electrode mount is coupled to a spindle shaft, each said spindle shaft rotatably coupled to said base plate.

9. An apparatus in accordance with claim 8 wherein each said electrode hub, each said electrode mount and each said spindle shaft comprises a longitudinal bore extending therethrough, said longitudinal bores of said spindle shaft coupled to said electrode mount coupled to said electrode hub of said first end portion align to form a first passageway extending from inside said electrode assembly cavity to outside said cavity, said longitudinal bores of said spindle shaft coupled to said electrode mount coupled to said electrode hub of said second end portion align to form a second passageway extending from inside said electrode assembly cavity to outside said cavity.

10. An apparatus in accordance with claim 8 wherein each electrode mount comprises a non-conductive material.

11. An electric discharge machining electrode assembly for a sample removal apparatus, said electrode assembly comprising an outer wall defining a substantially semi-cylindrical hollow cavity, said outer wall comprising:
a conductive first arcuate portion;
a conductive second arcuate portion; and
a non-conductive third arcuate portion positioned between and coupled to said first and second arcuate portions.

12. An electrode assembly in accordance with claim 11 wherein said outer wall further comprises a first end portion and a second end portion, each said first and said second end portion comprising:
a conductive first end section extending from said first arcuate portion;
a conductive second end section extending from said second arcuate portion;
a non-conductive third end section extending from said third arcuate portion; and
a conductive electrode hub, said first and second end sections extending from said electrode hub and said third end section coupled to said electrode hub.

13. An electrode assembly in accordance with claim 12 wherein said first end sections of said first and second end portions and said first arcuate portion defines a first electrode wing, said second end sections of said first and second end portions and said second arcuate portion defines a second electrode wing, and said third end sections of said first and second end portions and said third arcuate portion defines an electrode insulator, said first and second electrode wings each comprising a plurality of flushing bores extending through said outer wall and a plurality of interconnecting bores, each said interconnecting bore interconnecting at least two of said flushing bores.

14. An electrode assembly in accordance with claim 12 wherein each said electrode hub comprises a longitudinal bore extending therethrough.

15. An electric discharge machining sample removal apparatus for removing a material sample from a structural component in a boiling water nuclear reactor, the reactor comprising a reactor pressure vessel and a shroud, said apparatus comprising:
a base plate;
a motor mounted on said base plate; and
an electrode assembly rotatably coupled to said base plate and operatively coupled to said motor, said electrode assembly having a first end and a second end, and comprising:
a first electrode hub located at said first end;
a second electrode hub located at said second end;
a conductive first electrode wing portion extending from said first and second electrode hubs;
a conductive second electrode wing portion extending from said first and second electrode hubs; and
an electrode insulator extending between said first and second electrode wing portions and coupled to said first and second electrode hubs, said first and second electrode wing portions and said electrode insulator forming a substantially semi-cylindrical hollow cavity having an outer wall.

16. An apparatus in accordance with claim 15 wherein said outer wall comprises:
a conductive first arcuate portion;
a conductive second arcuate portion; and
a non-conductive third arcuate portion positioned between and coupled to said first and second arcuate portions.

17. An electrode assembly in accordance with claim 16 wherein said outer wall further comprises a first end portion and a second end portion, each said first and said second end portion comprising:
a conductive first end section extending from said first arcuate portion;
a conductive second end section extending from said second arcuate portion; and
a non-conductive third end section extending from said third arcuate portion, said first and second end sections extending from said electrode hub and said third end section coupled to said electrode hub.

18. An apparatus in accordance with claim 17 wherein said first and second electrode wing portions each comprise a plurality of flushing bores, extending through said outer wall, and a plurality of interconnecting bores, each said interconnecting bore interconnecting at least two of said flushing bores.

19. An apparatus in accordance with claim 15 wherein each electrode hub is coupled to an electrode mount, and each electrode mount is coupled to a spindle shaft, each said spindle shaft rotatably coupled to said base plate.

20. An apparatus in accordance with claim 19 wherein each said electrode hub, each said electrode mount and each said spindle shaft comprises a longitudinal bore extending therethrough, said longitudinal bores of said spindle shaft coupled to said electrode mount coupled to said electrode hub of said first end portion align to form a first passageway extending from inside said electrode assembly cavity to outside said cavity, said longitudinal bores of said spindle shaft coupled to said electrode mount coupled to said electrode hub of said second end portion align to form a second passageway extending from inside said electrode assembly cavity to outside said cavity.

21. An apparatus in accordance with claim 15 further comprising a clamping assembly coupled to said base plate, said clamping assembly comprising an extendable clamping cylinder sized and configured to engage the reactor pressure vessel to clamp said apparatus in place between the reactor pressure vessel and the shroud.

22. An apparatus in accordance with claim 15 further comprising a trap door assembly movably coupled to said base plate.

23. An apparatus in accordance with claim 22 wherein said trap door assembly comprises a door actuating cylinder coupled to said base plate and a trap door coupled to said door actuating cylinder, said door movable from an open position to a closed position to capture a sample.

24. An apparatus in accordance with claim 15 further comprising at least one drive belt operatively coupling said motor to said electrode assembly.

25. A method of excavating a material sample from a structural component in a nuclear reactor, the reactor comprising a reactor pressure vessel and a shroud with an annulus space between the pressure vessel and the shroud, said method comprising:
positioning an electric discharge machining sample removal apparatus in the annulus and adjacent the shroud;
activating the sample removal apparatus to machine a material sample from the shroud, the electric discharge machining sample removal apparatus comprising:
a base plate;
a motor mounted on the base plate; and
an electrode assembly rotatably coupled to the base plate and operatively coupled to the motor, the electrode assembly having a first end and a second end, and comprising:
a first electrode hub located at the first end;
a second electrode hub located at the second end;
a conductive first electrode wing portion extending from the first and second electrode hubs;
a conductive second electrode wing portion extending from the first and second electrode hubs; and
an electrode insulator extending between the first and second electrode wing portions and coupled to the first and second electrode hubs, the first and second electrode wing portions and the electrode insulator forming a substantially semi-cylindrical hollow cavity having an outer wall.

26. A method in accordance with claim 25 wherein the electrode assembly outer wall comprises:
a conductive first arcuate portion;
a conductive second arcuate portion; and
a non-conductive third arcuate portion positioned between and coupled to the first and second arcuate portions.

27. A method in accordance with claim 26 wherein the outer wall further comprises a first end portion and a second end portion, each first and second end portion comprising:
a conductive first end section extending from the first arcuate portion;
a conductive second end section extending from the second arcuate portion; and
a non-conductive third end section extending from the third arcuate portion, the first and second end sections extending from the electrode hub and the third end section coupled to the electrode hub.

28. A method in accordance with claim 27 wherein the first and second electrode wing portions each comprise a plurality of flushing bores extending through the outer wall, and a plurality of interconnecting bores, each interconnecting bore interconnecting at least two of the flushing bores.

29. A method in accordance with claim 28 wherein each electrode hub is coupled to an electrode mount, and each electrode mount is coupled to a spindle shaft, each spindle shaft rotatably coupled to the base plate, each electrode hub, each electrode mount and said spindle shaft comprises a longitudinal bore extending therethrough, the longitudinal bores of the spindle shaft coupled to the electrode mount coupled to the electrode hub of the first end portion align to form a first passageway extending from inside the electrode assembly cavity to outside the cavity, the longitudinal bores of the spindle shaft coupled to the electrode mount coupled to the electrode hub of the second end portion align to form a second passageway extending from inside the electrode assembly cavity to outside the cavity, said method further comprising removing swarf and dissociated hydrogen and oxygen gasses by flushing water through the longitudinal passageways and the flushing bores, or by suctioning through the longitudinal passageways and the flushing bores.

30. A method in accordance with claim 25 wherein the sample removal apparatus further comprises a clamping assembly coupled to the base plate, the clamping assembly comprising an clamping cylinder including an extendable plunger, and positioning an electric discharge machining sample removal apparatus in the annulus comprises activating the clamping cylinder to extend the plunger to engage the reactor pressure vessel to clamp the apparatus in place between the reactor pressure vessel and the shroud.

31. A method in accordance with claim 25 wherein the sample removal apparatus further comprises at least one drive belt operatively coupling the motor to the electrode assembly, and activating the sample removal apparatus to machine a material sample from the shroud comprises:
activating the motor to rotate the electrode assembly in a first direction; and
reversing the motor to rotate the electrode assembly in a second direction.

32. A method in accordance with claim 31 wherein the sample removal apparatus further comprises a trap door assembly movably coupled to the base plate, the trap door assembly comprising a door actuating cylinder coupled to the base plate and a trap door coupled to the door actuating cylinder, the door movable from an open position to a closed position to capture a sample, and said method further comprising actuating the door actuating cylinder to move the trap door from the open position to the closed position when the electrode assembly is moving in the second direction to trap the sample in the electrode cavity.
